(19) United States
(12) Patent Application Publication
(10) Pub. No.: US 2015/0316366 A1
(43) Pub. Date: Nov. 5, 2015

(54) SYSTEM FOR DETERMINING DIAMETER OF A SEAL

(71) Applicant: Caterpillar Inc., Peoria, IL (US)

(72) Inventors: Jay H. Cline, Hopewell, IL (US); Eric E. Halla, Peoria, IL (US)

(73) Assignee: Caterpillar Inc., Peoria, IL (US)

(21) Appl. No.: 14/799,600

(22) Filed: Jul. 15, 2015

(51) Int. Cl. G01B 5/08

(52) U.S. Cl. CPC G01B 5/08

(57) ABSTRACT

A system for determining diameter of a seal is provided. The system includes a frame. The system includes a first member mounted on the frame. The first member includes a first surface configured to receive a portion of the seal thereon. The system includes a hub movably mounted on the frame. The system includes a second member mounted on the hub. The second member includes a second surface configured to receive another portion of the seal thereon. The seal is removably disposed around the first and second members. The second member is moved with respect to the first member to retain the circular member in a tensioned configuration. The system includes a measuring device disposed on the frame. The measuring device is configured to measure a distance between the first member and the second member to determine the diameter of the seal.

### TECHNICAL FIELD

The present disclosure relates to a system for measuring a dimension of a seal, and more particularly to a system for measuring a dimension of a large sized seal.

### BACKGROUND

Seals of various cross sectional diameters may have large diameter glands or grooves to receive these large seals. Such seals are used in numerous applications typically to seal two rigid components which often encase a fluid and therefore the complete assembly being sealed at the face between these two components. Large diameter seals may be used in various applications such as, for example, transmissions, and engine crankcases. Since many seals are typically made from elastomeric materials they are pliable.

During quality control exercises seals may be measured to make sure they conform to the required dimensions. It is conceivable that an unmarked seal may need to be identified for conformity for a specific application. For measuring a large diameter seal it may be placed on a flat surface and a cloth tape measuring tool is used to measure the perimeter or length of the seal. However, this method is subject to inaccuracy because the cloth tape may not be properly aligned along the length of the pliable seal and such measurement technique is known to not provide a highly accurate measurement. Alternatively, zero contact optical coordinate measuring machines may also be used for measuring the diameter of such large seals. However, such measuring system may be used for seals having diameter only below 610 mm.

U.S. Pat. No. 3,943,632 (the '632 patent) discloses an apparatus for measuring the length of curved segments including loading pairs of rollers with one roller of each pair being driven, positioning switches, positioning shaped reciprocally movable elements defining a hollow to house the segment to be measured and movable arms and feelers to measure the segment. The hollow has a shape corresponding to the theoretical shape of the segment. The movable elements are fitted with openings for at least one of the ends of the segment. The feelers are arranged in correspondence with the openings to cooperate with the relevant ends of the segment. However, the apparatus of the '632 patent has multiple components which may increase a cost and design complexity of the apparatus.

### SUMMARY OF THE DISCLOSURE

In an aspect of the present disclosure, a system for measuring a dimension of a seal is provided. The system includes a frame. The system also includes a first member mounted on the frame. The first member includes a first surface configured to receive a portion of the seal thereon. The system further includes a hub movably mounted on the frame. The system further includes a second member mounted on the hub. The second member includes a second surface configured to receive another portion of the seal thereon. The seal is removably disposed around the first member and the second member. Further, the second member is moved with respect to the first member to retain the seal in a tensioned configuration. The system also includes a measuring device disposed on the frame. The measuring device is configured to measure a distance between the first member and the second member to determine the diameter of the seal.

Other features and aspects of this disclosure will be apparent from the following description and the accompanying drawings.

### BRIEF DESCRIPTION OF THE DRAWINGS

FIG. 1 illustrates a perspective view of a system for determining a diameter of a seal, according to an embodiment of the present disclosure;

FIG. 2 illustrates a front view of the system of FIG. 1 showing the seal in a slack configuration;

FIG. 3 illustrates a front view of the system of FIG. 1 showing the seal in a tensioned configuration;

FIG. 4 illustrates a sectional view of the system along a line A-A′ in FIG. 3; and

FIG. 5 illustrates a perspective view of the system, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

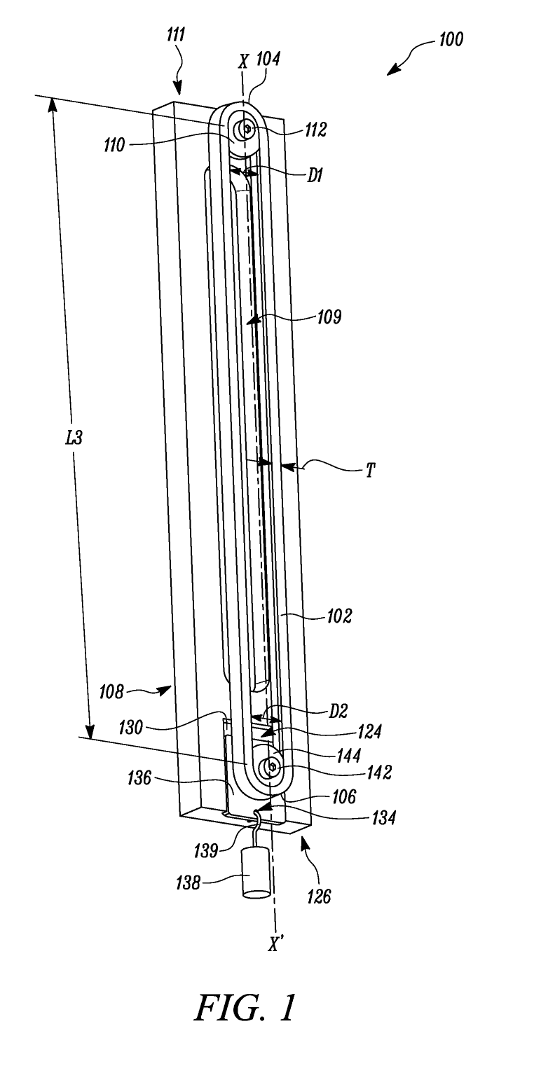

FIG. 1 shows a perspective view of a system 100 for measuring a dimension of a seal 102, according to an embodiment of the present disclosure. The seal 102 may be disposed in an interface between two metallic parts of a machine. Further, the seal 102 may be made of an elastomeric material, such as rubber, for example.

The system 100 includes a frame 108. In an exemplary embodiment, the frame 108 may be a 3D printed frame that can be mounted vertically on a surface, for example, a wall. The frame 108 includes a cutout 109. The cutout 109 may reduce a weight of the frame 108 to enable manual handling.

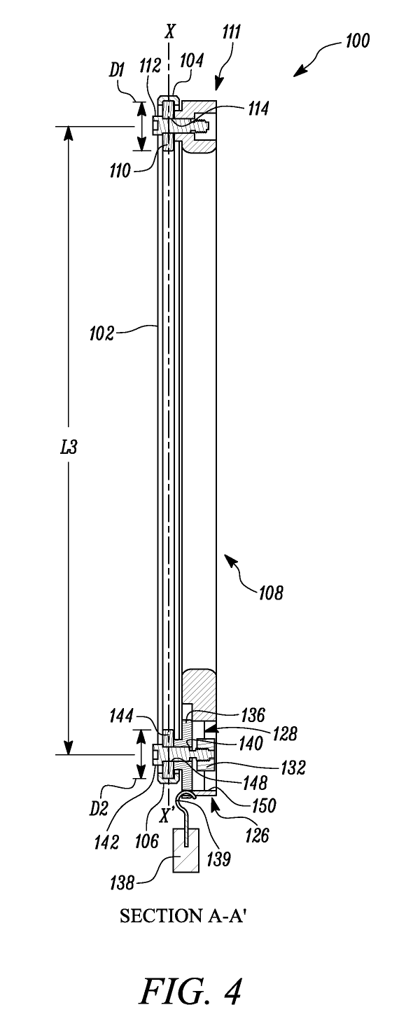

The system 100 includes a first member 110 mounted on a first end 111 of the frame 108. The first member 110 is mounted on the frame 108 via a first pin member 112. The first member 110 further defines a first opening 114 (shown in FIG. 4) which receives the first pin member 112.

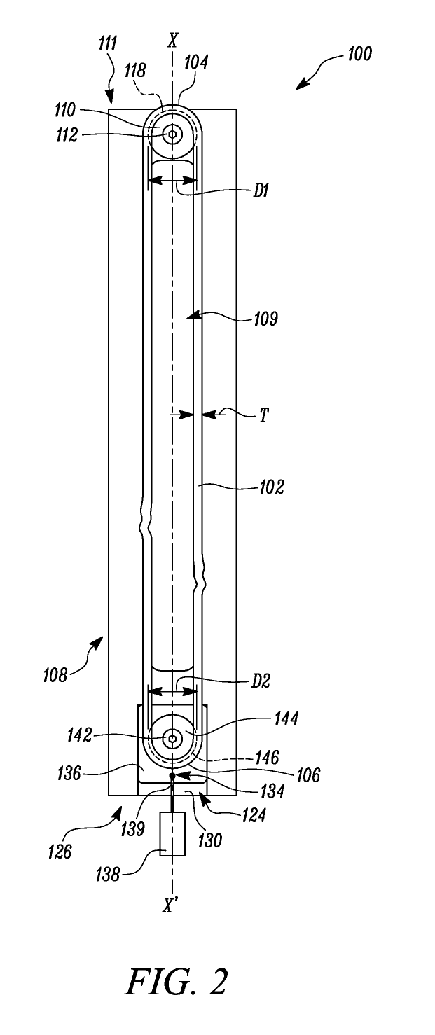

Referring to FIG. 2, the first member 110 includes a first surface 118 configured to receive a first portion 104 of the seal 102 thereon. The first member 110 is a disc shaped structure having a diameter “R1”.

The frame 108 includes a cavity 124 which is positioned near a second end 126 of the frame 108. The frame 108 defines a longitudinal axis XX′ extending between the first end 111 and the second end 126. The frame 108 also includes a channel 128 (shown in FIG. 4) defined in a wall 130 of the frame 108. The channel 128 is positioned near to the second end 126 of the frame 108. The channel receives a nut 132 (shown in FIG. 4). The nut 132 is movable along the longitudinal axis XX′. Further, the nut 132 is substantially T-shaped and slides with respect to the wall 130 (shown in FIG. 1) of the channel 128. The frame 102 further includes a stop 150 (shown in FIG. 4). The stop 150 may restrict a movement of the nut 132 along the longitudinal axis XX′.

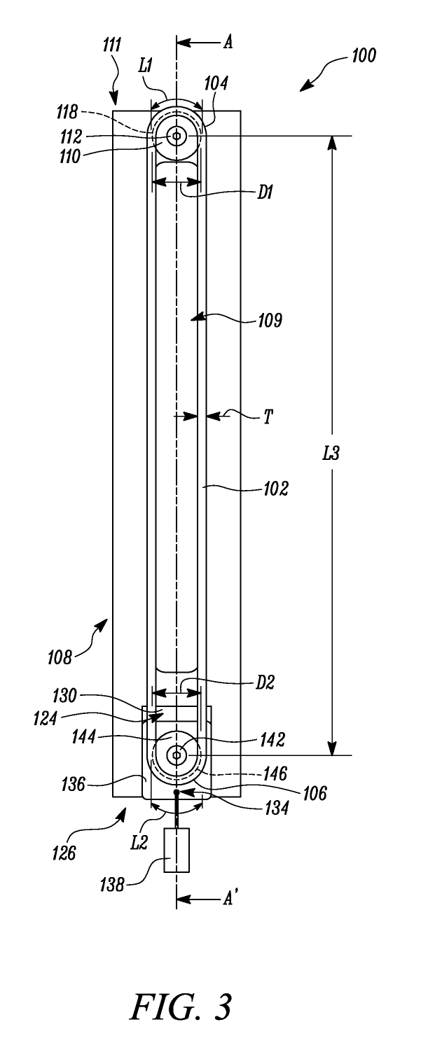

Referring to FIGS. 3 and 4, the system 100 further includes a hub 136 movably mounted on the frame 108. The hub 136 may move along the longitudinal axis XX′ within the cavity 124 of the frame 108. The hub 136 defines a second opening 140. The second opening 140 is positioned near to the second end 126 of the frame 108. The second opening 140 receives a second pin member 142 therethrough. The second pin member 142 couples the hub 136 with the nut 132. The second pin member 142 further includes a threaded portion (not shown) that may engage with threads (not shown) of the nut 132. The hub 136 also defines a hole 134 which receives a pulling member 138. The pulling member 138 is a weight which moves the hub 136 along the longitudinal axis XX′. The pulling member 138 includes a hook portion 139 which is received within the hole 134 of the hub 136.

The system 100 further includes a second member 144 mounted on the hub 136. The second member 144 includes a second surface 146. The second surface 146 is configured to receive a second portion 106 of the seal 102. The second member 144 is a disc shaped structure having a diameter “D2”. Though, the second member 144 is shown to have a circular shape, it may be contemplated that the second member 144 may have any shape such as an ellipse, a circular segment, and the like. Further, the second member 144 defines a third opening 148 aligned with the second opening 140 of the hub 136 with respect to the longitudinal axis XX′. The third opening 148 receives the second pin member 142 to couple the second member 144 with the hub 136 and the nut 132.

The system 100 further includes a measuring device (not shown in FIGS. 1 to 4) disposed on the frame 108. The measuring device is configured to measure a distance “L3” between the first member 110 and the second member 144 at the second position. The distance “L3” may be then used to determine an inner diameter of the seal 102. The distance “L3” may correspond to a distance between a center of the first member 110 and a center of the second member 144. The inner diameter “Di” of the seal 102 may be determined based on the diameter “D1” of the first member 110, the diameter “D2” of the second member 144, and the distance “L3” between the first and second members 110, 144.

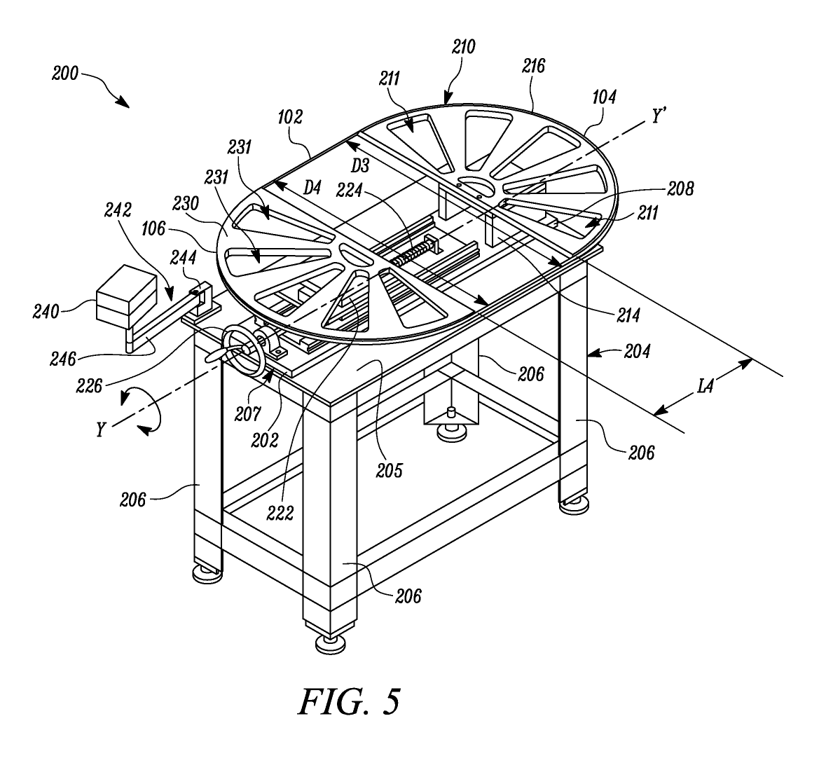

Further, an outer diameter “Do” of the seal 102 may be determined based on a thickness “T” of the seal 102, and the inner diameter “Di” of the seal 102. The outer diameter “Do” and the inner diameter “Di” of the seal 102 may be calculated manually or automatically. The measuring device may include a reference scale engraved on a top surface of the frame 108. In an alternate embodiment, the measuring device may be a linear encoder (shown in FIG. 5) configured to measure the diameter of the seal 102. Further, after determination of the inner and/or outer diameters “Di”, “Do”, the second member 144 may be moved upwards along the longitudinal axis XX′ such that a slack is introduced in the seal 102. Thereafter, the seal 102 may be easily removed from the first and second members 110, 144.

FIG. 5 illustrates a perspective view of the system 200 for determining a diameter of the seal 102, according to another embodiment of the present disclosure. The system 200 includes a frame 202 supported on a test stand 204. The test stand 204 includes a base member 205. The base member 205 of the test stand 204 is coupled to the frame 202 of the system 200. The base member 205 may be coupled to the frame 202 via various methods, such as mechanical fasteners, adhesives, welding, and the like. Further, the test stand 204 includes four such support members 206. Further, a height of each of the support members 206 may also be adjustable based on various requirements.

The frame 202 defines a longitudinal axis YY′ extending between a first end 207 and a second end 208 of the frame 202. The system 200 further includes a first member 210 mounted to the frame 202. The first member 210 is fixedly coupled to a first support 214 extending from the frame 202 along a direction perpendicular to the longitudinal axis YY′. The first member 210 may include multiple first cutouts 211. The first cutouts 211 may reduce a weight of the first member 210 to enable easy handling. The first member 210 further includes a first surface 216.

Though the first member 210 is shown to have a semi circular shape having a diameter “D3”, it may be contemplated that the first member 210 may have any curvilinear shape, such as ellipse, and circle. The first surface 216 corresponds to a circular surface along a circumference of the first member 210. The first surface 216 is configured to receive the first portion 104 of the seal 102 thereon. The system 200 further includes a hub 222 movably mounted on the frame 202. The hub 222 is operatively coupled to a lead screw 224. The system 200 further includes a wheel handle 226 coupled to the lead screw 224. The wheel handle 226 is configured to operatively rotate the lead screw 224. Upon rotation of the wheel handle 226, the lead screw 224 may rotate about the longitudinal axis YY′. Due to the rotation of the lead screw 224, the hub 222 may translate along the longitudinal axis YY′. The hub 222 may be movable by other mechanisms, such as a gear mechanism, and motors. Further, the wheel handle 226 may be moved automatically or manually.

Further, the system 200 includes a second member 230 mounted on the hub 222. Though the second member 230 is shown to have a semi circular shape having a diameter “D4”, it may be contemplated that the second may have any shape such as, an ellipse, circle, and the like. The second member 230 may include multiple second cutouts 231. The second cutouts 231 may reduce a weight of the second member 230 to enable easy handling. The second member 230 is configured to move along the longitudinal axis YY′ based on a movement of the hub 222. The second member 230 includes a second surface 232 which receives the second portion 106 of the seal 102 thereon.

The system 200 further includes a measuring device 240 disposed on the frame 202. The measuring device 240 is adjustably coupled to the frame 202 via a support assembly 242. The support assembly 242 includes a support block 244 coupled to the base member 205 of the frame 202. The support assembly 242 further includes a support arm 246 adjustably coupled to the support block 244. The measuring device 240 may measure a distance “L4” between the first member 210 and the second member 230 at the position of the second member 230. The distance “L4” may be used to determine the diameter of the seal 102. Specifically, the inner diameter “Di” of the seal 102 may be determined based on the diameter “D3” of the first member 210, the diameter “D4” of second member 230, and the distance “L4” between the first and second members 210, 230. Further, an outer diameter “Do” of the seal 102 may also be determined based on the inner diameter “Di” and a thickness “T” of the seal 102. The measuring device 240 may include a linear encoder which detects a position of the second member 230 with respect to the first member 210. In an example, the encoder may be an optical encoder. However, any suitable type of encoder may be used for detecting a position of the second member 230 with respect to the first member 210.

The measuring device 240 may also be connected to a controller (not shown). The controller may receive an input corresponding to the position of the second member 230 from the encoder to determine the distance “L4” between the first member 210 and the second member 230. Further, the controller may also receive user inputs corresponding to the thickness “T”, the diameter “D3” of the first member 210, and the diameter “D4” of the second member 230. The controller may also include an output module (not shown) configured to calculate the inner and outer diameters “Di”, “Do” of the seal 102 based on the inputs from the measuring device 240 and user inputs. In an embodiment, the controller may be communicably coupled to a display panel (not shown). An output corresponding to the inner and outer diameters “Di”, “Do” of the seal 102 may also be displayed on the display panel.

Further, after determination of the inner and/or outer diameters “Di”, “Do”, the second member 230 may be moved along the longitudinal axis XX′ towards the first member 210 such that a slack is introduced in the seal 102. Thereafter, the seal 102 may be easily removed from the first and second members 210, 230.

### INDUSTRIAL APPLICABILITY

The present disclosure is related to the systems 100, 200. As described earlier, the systems 100, 200 may be used to determine the diameter of the seal 102. The systems 100, 200 may be used to measure an inner diameter and/or an outer diameter of the seal 102. Specifically, the systems 100, 200 may be used to measuring a dimension of the seal 102 based on the distance between the first members 110, 210 and the second members 144, 230, and a corresponding diameter of each of the first members 110, 210 and the second members 144, 230. The systems 100, 200 further include the measuring device to determine the distance between the first members 110, 210 and the second members 144, 230. Further, the measuring device may be a linear encoder to facilitate accurate determination of the diameter of the seal 102.

Referring to FIGS. 1 to 4, the seal 102 is removably disposed around the first member 110 and the second member 144. The second member 144 is disposed at a first position (shown in FIG. 2). The first position of the second member 144 corresponds to a slack configuration of the seal 102. Due to the weight of the pulling member 138, the hub 136 and the second member 144 is moved with respect to the first member 110 to retain the seal 102 in a tensioned configuration (shown in FIG. 3). Thus, the second member 144 is moved to a second position such that the seal 102 is tensioned with substantially zero slack. The weight of the pulling member 138 may be suitably chosen to obtain zero slack without deforming the seal 102. Further, the first portion 104 of the seal 102 is disposed along a length “L1” on the first surface 118. The length “L1” may vary depending on a diameter “Dl” of the first member 110. The second portion 106 of the seal 102 is disposed along a length “L2” on the second surface 146. The length “L2” may vary depending on a diameter “D2” of the second member 144.

Referring to FIG. 5, the second portion 106 of the seal 102 is disposed along a circumference of the second member 230. Further, upon movement of the hub 222, the second member 230 is moved to a position, as shown in FIG. 3, to retain the seal 102 in a tensioned configuration. Such movement of the second member 230 may tension the seal 102 with substantially zero slack without deforming the seal 102.

Further, the systems 100, 200 may also enable easy mounting of the seal 102 on the first members 110, 210 and the second members 144, 230. The seal 102 may also be tensioned conveniently by use of the pulling member 138 of the system 100 and the wheel handle 226 of the system 200. Thus, the systems 100, 200 may allow fast, easy and non-destructive measurement of the diameter of the seal 102. Specifically, the seal 102 may be used after measurement of the diameter.

The systems 100, 200 may also have a simple and lightweight design, thereby allowing the systems 100, 200 to be mounted on a wall or supported on a horizontal surface. Moreover, shape and dimensions of the first members 110, 210 and the second members 144, 230 may be suitably chosen based on a dimension of the seal 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for measuring a dimension of a seal, the system comprising:
a frame;
a first member mounted on the frame, the first member comprising a first surface configured to receive a portion of the seal thereon;
a hub movably mounted on the frame;
a second member mounted on the hub, the second member comprising a second surface configured to receive another portion of the seal thereon, wherein the seal is removably disposed around the first member and the second member, and wherein the second member is moved with respect to the first member to retain the seal in a tensioned configuration; and
a measuring device disposed on the frame, the measuring device configured to measure a distance between the first member and the second member to determine the diameter of the seal.
